(19) United States
(12) Patent Application Publication
(10) Pub. No.: US 2020/0016792 A1
(43) Pub. Date: Jan. 16, 2020

(54) CONCAVE CUTTING TABLE OF CERAMIC SAW

(71) Applicant: Chin-Chin Chang, Taichung City (TW)

(72) Inventor: Chin-Chin Chang, Taichung City (TW)

(21) Appl. No.: 16/033,520

(22) Filed: Jul. 12, 2018

(51) Int. Cl. B28D 7/02; B28D 1/04; B28D 7/04

(52) U.S. Cl. CPC B28D 7/02; B28D 7/04; B28D 1/04

(57) ABSTRACT

A ceramic saw includes a sliding cutting table including two intermediate islands, a flat, left portion to the left of the intermediate islands, and a flat, right portion to the right of the intermediate islands; a first longitudinal groove inclined and disposed between the left portion and the intermediate islands, a second longitudinal groove between the intermediate islands, and a third longitudinal groove inclined and disposed between the right portion and the intermediate islands; a plurality of inclined, transverse grooves across the left portion, the right portion, and the intermediate islands; a rectangular groove formed along four edges of the cutting table; a first drain disposed on the first longitudinal groove, a second drain disposed on the second longitudinal groove, and a third drain disposed on the third longitudinal groove; and the first, second and third longitudinal grooves, the transverse grooves, and the rectangular groove communicate with one another.

### BACKGROUND OF THE INVENTION

### 1. Field of the Invention

The invention relates to power saws and more particularly to a power saw for cutting a ceramic tile having a concave cutting table for facilitating the collection of water flowing off of the cutting table and sludge formed from the water mixing with the saw dust by a tray.

### 2. Description of Related Art

U.S. Pat. No. 9,962,858 to the present inventor Chang discloses a ceramic and masonry power saw comprising a cutting head assembly including a circular saw blade, an electric motor for driving the saw blade, and a support member for supporting both the saw blade and the motor; a rectangular box shaped frame including two hollow members at front and rear ends respectively, two side members interconnecting the end members, two side supports interconnecting the end members, a tray configured to removably dispose on the frame by passing through the hollow member, and a first water pan communicating with the tray; a rail assembly disposed on the frame; and a cutting table including a main platform slidably disposed on the rail assembly, an auxiliary platform secured to one side of the main platform, and a second water pan releasably secured to the main platform.

However, the main platform of the cutting table is flat and does not facilitate the drain of the water mixed with saw dust. Thus, the need for improvement still exists.

### SUMMARY OF THE INVENTION

It is therefore one object of the invention to provide a saw for cutting a workpiece, comprising a rectangular cutting table including two parallel sets of a plurality of rollers disposed on a bottom; a gauge strip formed with a front end of the cutting table; a removable tray under the cutting table; a rectangular frame including two parallel rails on a top with the sets of rollers rotatably disposed thereon, and a wheeled folding leg assembly disposed under the removable tray; and a cutting head assembly disposed above the cutting table and secured to the frame, the cutting head assembly including a circular saw blade, an electric motor for driving the saw blade, and a nozzle; wherein the cutting table is slidably mounted on the parallel rails and includes two intermediate islands, a flat, left portion disposed to the left of the intermediate islands, and a flat, right portion disposed to the right of the intermediate islands; a first longitudinal groove inclined and disposed between the left portion and the intermediate islands, a second longitudinal groove between the intermediate islands, and a third longitudinal groove inclined and disposed between the right portion and the intermediate islands; a plurality of inclined, transverse grooves across the left portion, the right portion, and the intermediate islands; a rectangular groove formed along an edge of the cutting table; a first drain disposed on the first longitudinal groove, a second drain disposed on the second longitudinal groove, and a third drain disposed on the third longitudinal groove; and the first, second and third longitudinal grooves, the inclined, transverse grooves, and the rectangular groove communicate with one another.

The above and other objects, features and advantages of the invention will become apparent from the following detailed description taken with the accompanying drawings.

### BRIEF DESCRIPTION OF THE DRAWINGS

FIG. 1 is a perspective view of a ceramic saw according to the invention;

FIG. 2 is another perspective view of the ceramic saw after the cutting table has been slid;

FIG. 3 is a perspective view of the cutting table;

FIG. 4 is a top view of a portion of the cutting table of FIG. 3;

FIG. 4A is an enlarged view of the left bottom corner of FIG. 4

FIG. 5 is a longitudinal sectional view of line A-A of FIG. 4;

FIG. 5A is an enlarged view of the left side of FIG. 5;

FIG. 6 schematically depicts the complete ceramic saw shown in FIG. 1;

FIG. 6A is similar to FIG. 5A showing water flow on the cutting table in a cutting operation; and

FIG. 7 is a top view of the cutting table schematically showing water flow on the cutting table in a cutting operation.

### DETAILED DESCRIPTION OF THE INVENTION

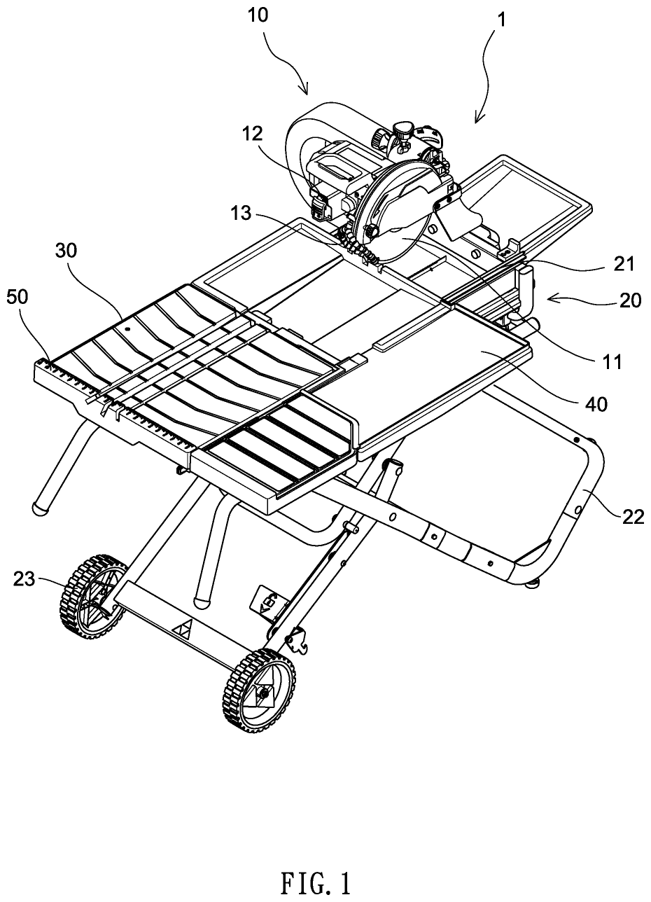

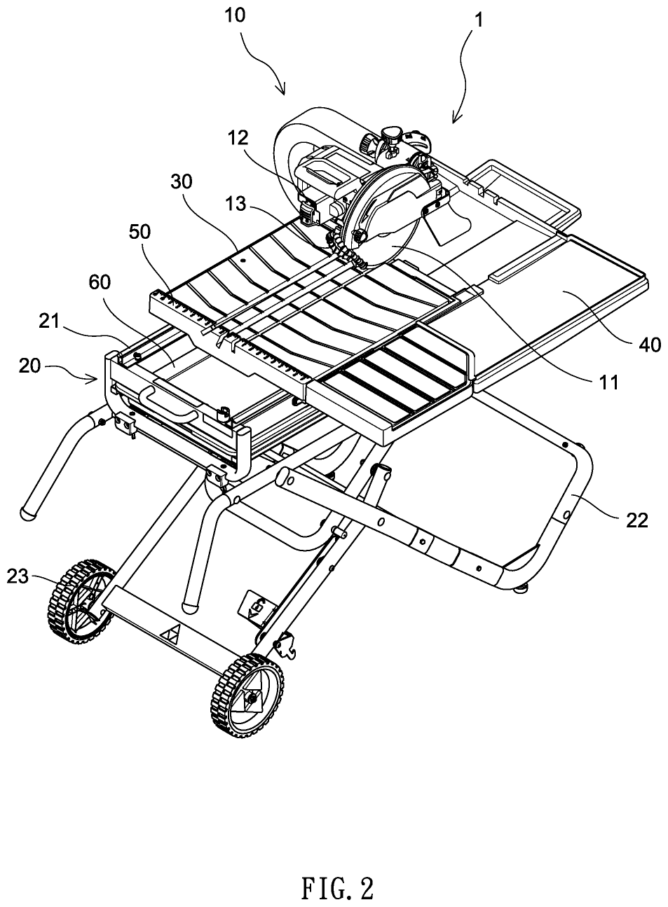

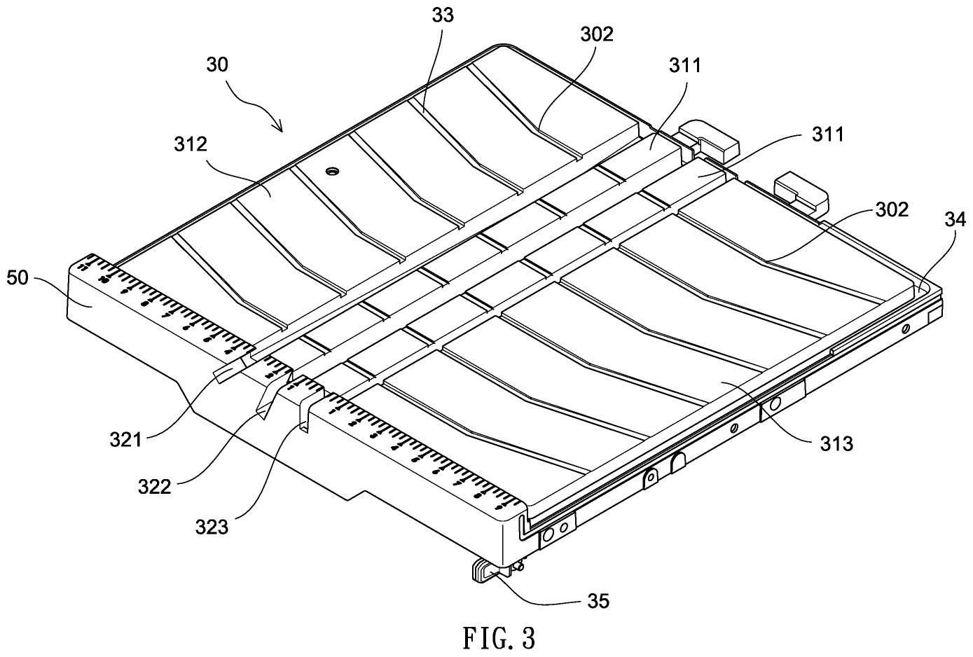

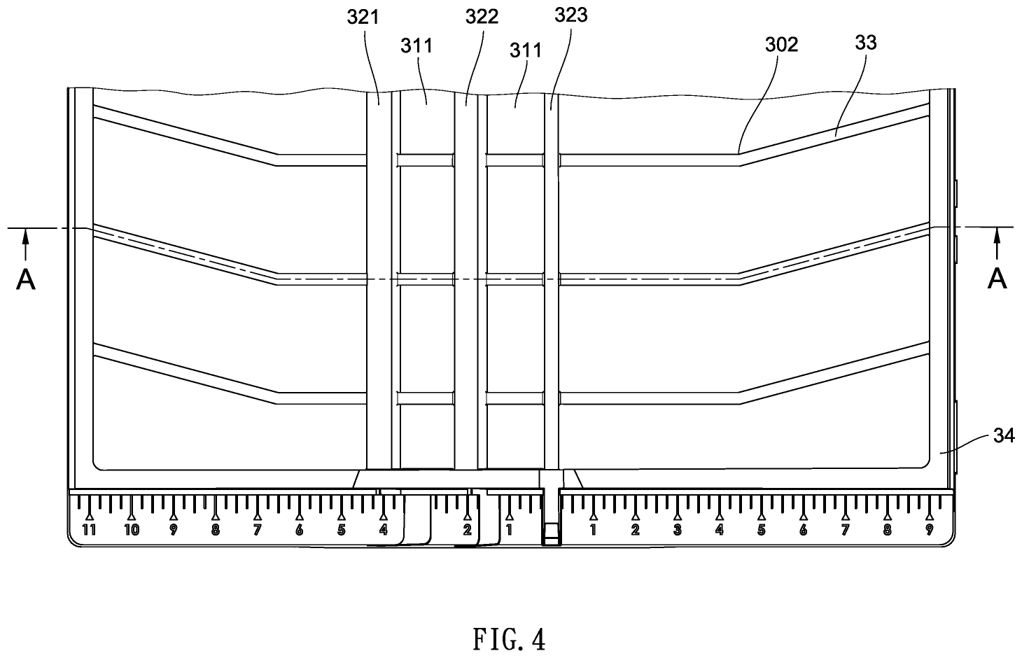

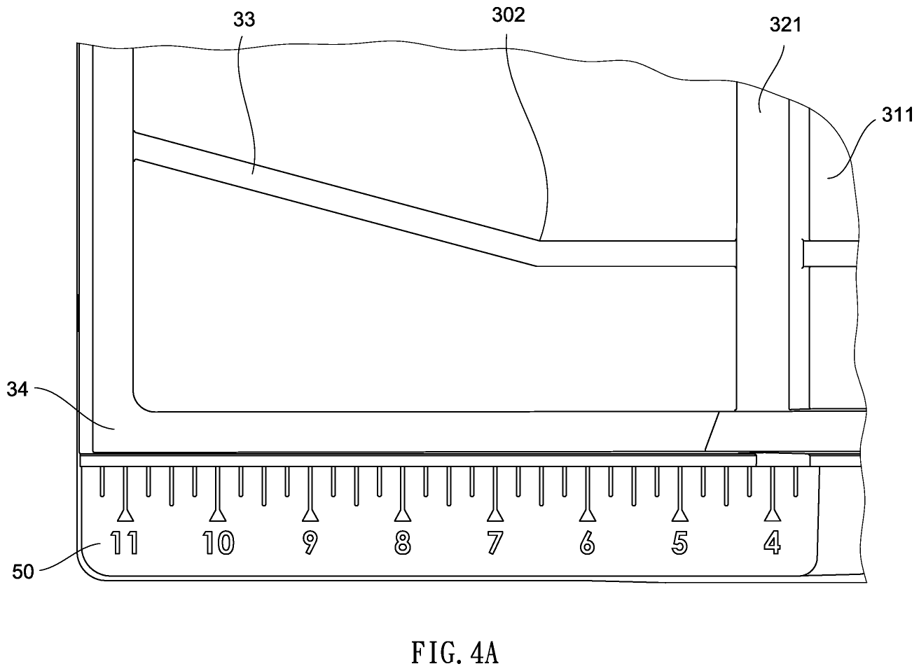

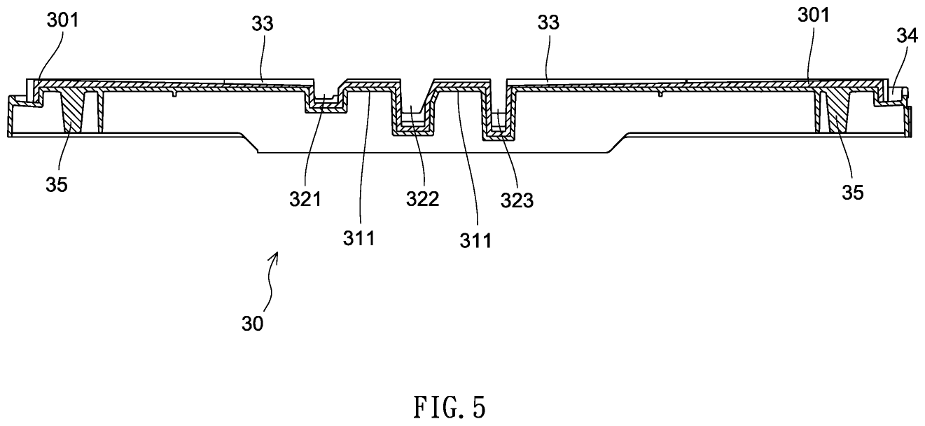

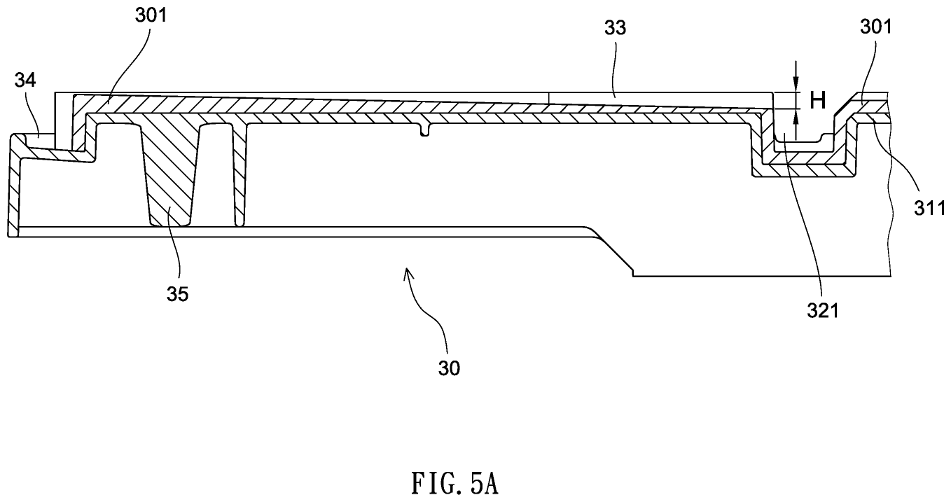

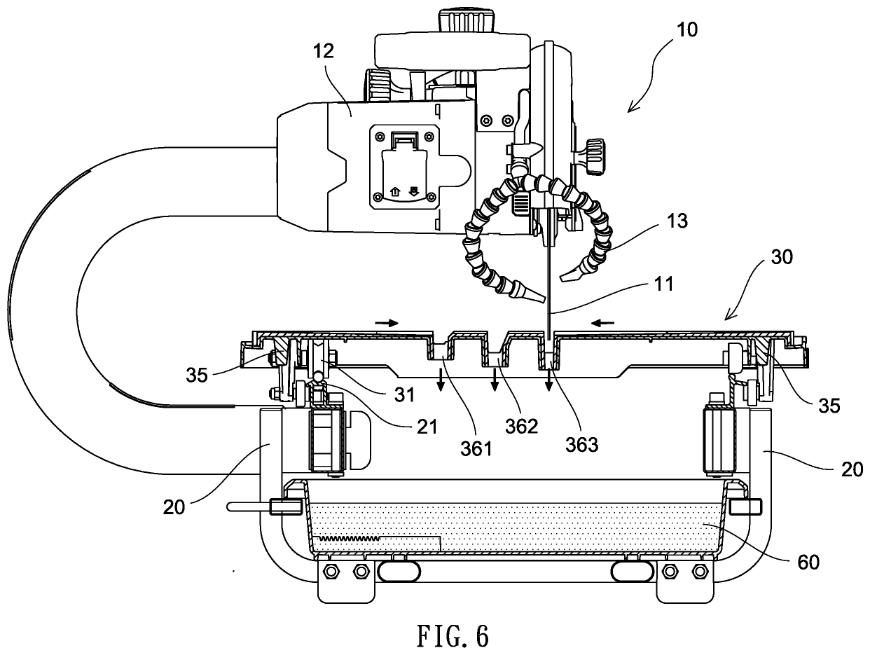

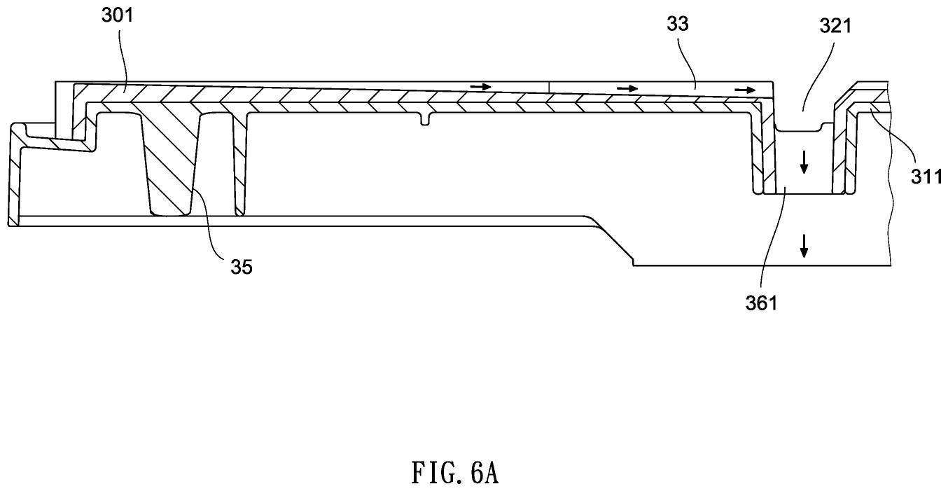

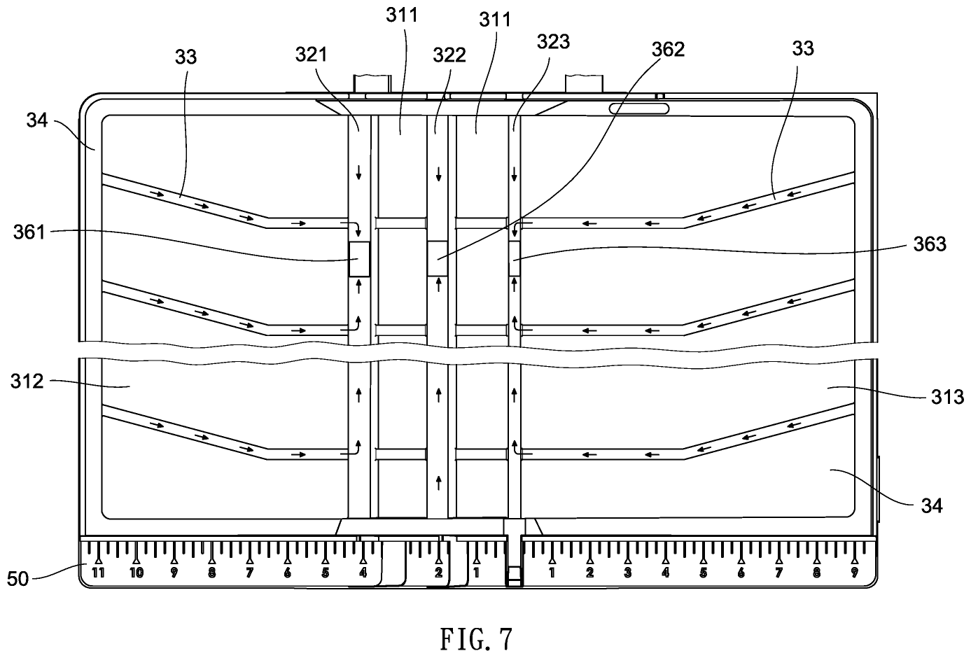

Referring to FIGS. 1 to 7, a ceramic saw 1 in accordance with the invention comprises the following components as discussed in detail below.

A rectangular cutting table 30 is provided. An extension board 40 is mounted at one side of the cutting table 30. A gauge strip 50 is formed with a front end of the cutting table 30. Two parallel sets of a plurality of rollers 31 are provided on a bottom of the cutting table 30. A removable tray 60 is disposed under the cutting table 30.

A cutting head assembly 10 includes a circular saw blade 11 for cutting a workpiece (e.g., ceramic tile), an electric motor 12 for driving the saw blade 11, and a nozzle 13 having one end in fluid communication with a water reservoir not shown) Bed with cutting table. A pump (not shown) is powered by the motor 12 for pumping water out of the water reservoir to the nozzle 13.

A rectangular frame 20 includes two parallel rails 21 on a top with the sets of the plurality of rollers 31 rotatably disposed thereon, a folding leg assembly 22 disposed under the tray 60, and two front wheels 23 rotatably mounted on two sides of a front end of the folding leg assembly 22. The cutting head assembly 10 is secured to one side of the frame 20.

The cutting table 30 as the subject of the invention is covered by a rubber layer 301 and includes two intermediate islands 311, a flat, left portion 312 disposed to the left of the intermediate islands 311, and a flat, right portion 313 disposed to the right of the intermediate islands 311; a first longitudinal groove 321 inclined and disposed between the left portion 312 and the intermediate islands 311, a second longitudinal groove 322 between the intermediate islands 311, and a third longitudinal groove 323 inclined and disposed between the right portion 313 and the intermediate islands 311; a plurality of inclined, transverse grooves 33 across the left portion 312, the right portion 313, and the intermediate islands 311, each transverse groove 33 having two bent points 302 at the left portion 312 and the right portion 313 respectively; a rectangular groove 34 along four edges of the cutting table 30 and having left and right portion inclined inward; two parallel bottom slides 35 slidably mounted besides the sets of rollers 31 respectively; and a first drain 361 on a center of the first longitudinal groove 321, a second drain 362 on a center of the second longitudinal groove 322, and a third drain 363 on a center of the third longitudinal groove 323.

The first, second and third longitudinal grooves 321, 322, 323; the transverse grooves 33; and the groove 34 communicate with one another. The first, second and third longitudinal grooves 321, 322, 323 have front ends passing through the gauge strip 50. There is a height difference H between the left edge of the left portion 312 and the right edge thereof. Similarly, while not shown, there is a height difference between the left edge of the right portion 313 and the right edge thereof because the right portion 313 is a mirror image of the left portion 312.

A cutting operation of the ceramic saw 1 is described in detail below. First, an employee positions a workpiece (e.g., a ceramic tile) on the cutting table 30 by pushing or pulling the sets of rollers 31 on the parallel rails 21. Next, the employee turns on power to activate the motor 12 to rotate the saw blade 11 and power the pump to speed up a flow of the water directing at a portion of the workpiece being cut by the saw blade 11 after the water exiting the nozzle 13. Thus, the portion of the workpiece being cut by the saw blade 11 is cooled. The water and sludge formed from the water mixing with the saw dust flow through the first, second and third longitudinal grooves 321, 322, 323; the transverse grooves 33; and the rectangular groove 34. The water and the sludge then flow to the first, second and third drains 361, 362 and 363 due to inclination of the transverse grooves 33 toward a longitudinal central portion of the cutting table 30. Further, the water and the sludge are prevented from being spilled. Finally, the water and the sludge are collected by the tray 60 after passing through the first, second and third drains 361, 362 and 363.

While the invention has been described in terms of preferred embodiments, those skilled in the art will recognize that the invention can be practiced with modifications within the spirit and scope of the appended claims.

What is claimed is:

1. A saw for cutting a workpiece, comprising:
a rectangular cutting table including two parallel sets of a plurality of rollers disposed on a bottom;
a gauge strip formed with a front end of the cutting table;
a removable tray under the cutting table;
a rectangular frame including two parallel rails on a top with the sets of rollers rotatably disposed thereon, and a wheeled folding leg assembly disposed under the removable tray; and
a cutting head assembly disposed above the cutting table and secured to the frame, the cutting head assembly including a circular saw blade, an electric motor for driving the saw blade, and a nozzle;
wherein the cutting table is slidably mounted on the parallel rails and includes:
two intermediate islands, a flat, left portion disposed to the left of the intermediate islands, and a flat, right portion disposed to the right of the intermediate islands;
a first longitudinal groove inclined and disposed between the flat, left portion and the intermediate islands, a second longitudinal groove between the intermediate islands, and a third longitudinal groove inclined and disposed between the flat, right portion and the intermediate islands;
a plurality of inclined, transverse grooves across the flat, left portion, the flat, right portion, and the intermediate islands;
a rectangular groove formed along an edge of the cutting table;
a first drain disposed on the first longitudinal groove, a second drain disposed on the second longitudinal groove, and a third drain disposed on the third longitudinal groove; and
the first, second and third longitudinal grooves, the inclined, transverse grooves, and the rectangular groove communicate with one another.

2. The saw of claim 1, wherein the cutting table comprise an extension board at one side.

3. The saw of claim 1, further comprising a rubber layer disposed on the cutting table.

4. The saw of claim 1, wherein the cutting table further comprises two parallel bottom slides slidably mounted besides the sets of rollers.

5. The saw of claim 1, wherein the first, second and third longitudinal grooves have front ends passing through the gauge strip.

6. The saw of claim 1, wherein each inclined, transverse groove includes two bent points at the left portion and the right portion respectively.

7. The saw of claim 1, wherein the rectangular groove has a right portion inclined inward, and a left portion incline inward.
